(19) United States
(12) Patent Application Publication
(10) Pub. No.: US 2026/0233998 A1
(43) Pub. Date: Aug. 13, 2026

(54) A METHOD FOR RECOVERY OF LITHIUM

(71) Applicant: NORTHVOLT REVOLT AB, Stockholm (SE)

(72) Inventors: Andrea MARÍA BURGOS PARRA, Stockholm (SE); Robert JENSEN, Västerås (SE); Alejandro Gracia TABUENCA, Västerås (SE); Mahmood ALEMRAJABI, Solna (SE)

(21) Appl. No.: 19/154,537

(22) PCT Filed: Feb. 7, 2024
(86) PCT No.: PCT/EP2024/053057

§ 371 Date: Aug. 7, 2025

(30) Foreign Application Priority Data
Feb. 8, 2023 (SE) 2350118-2

(51) Int. Cl. C01B 25/30; B01D 61/44; C01D 5/00; C01D 15/02; C22B 3/22; C22B 7/00; C22B 26/12; H01M 10/54

(52) U.S. Cl. CPC C01B 25/301; B01D 61/445; C01B 25/306; C01D 5/00; C01D 15/02; C22B 3/22; C22B 7/006; C22B 26/12; H01M 10/54

(57) ABSTRACT

The disclosure provides a method for recovery of lithium such as recovery from an energy storing device or a component thereof. The method comprises the steps of: i) providing a lithium-containing aqueous residual solution; ii) adding H₃PO₄ and/or Na₃PO₄ to the aqueous residual solution in the presence of a pH adjuster providing a pH of from 9 to 10 at a temperature of from about 20° C. to about 65° C. thereby precipitating Li₃PO₄ and forming a filtrate, said H₃PO₄ and/or Na₃PO₄ being added in a molar ratio with respect to the lithium present in the aqueous solution from 1:1 to 1.5:1; and iii) separating the Li₃PO₄ from the filtrate.

### TECHNICAL FIELD

The present disclosure relates to a method for recovery of lithium. More specifically the present disclosure relates to a method for recovery of lithium from an energy storing device such as a battery or in relation to manufacturing of a cathode active material.

### BACKGROUND

The transition to a more sustainable society prompts the development of new and efficient energy storage devices such as batteries to meet the growing demand for electricity and compliance with climate goals. However, many of the materials of battery components such as battery metals are scarce, expensive and involve mining associated with negative environmental impact and social costs. Recovery is therefore key when moving towards fossil fuel free electrification.

Lithium-ion batteries are one of the most common and popular kind of batteries. Therefore, there is an increasing demand for lithium making recovery of lithium from lithium batteries and components thereof an attractive option. Consequently, there is a growing interest in recovery of lithium in relation to lithium based batteries. In particular, there is an interest in recovery methods that are cost-effective, environmentally friendly and allow for reusing the lithium in a desired application. Unfortunately, however, it has proven difficult avoid losses in the recovery due to e.g., problems associated with precipitation and/or separation of the lithium. There is therefore a need for methods allowing for improved recovery of lithium.

### SUMMARY

It is an object of the present disclosure to overcome or at least mitigate some of the problems associated with recovery of lithium such as recovery of lithium from an energy storing device or components thereof. Further, it is an object of the present disclosure to provide aspects and/or advantages not provided by hitherto known techniques.

The aforementioned object(s) is/are wholly or at least partly achieved as described by a method for recovery of lithium from an aqueous residual solution comprising one or more lithium salts, said method comprising the steps of:
i) providing a lithium-containing aqueous residual solution;
ii) adding H₃PO₄ and/or Na₃PO₄ to the aqueous residual solution in the presence of a pH adjuster providing a pH of 6 or above thereby precipitating Li₃PO₄ and forming a filtrate, said H₃PO₄ and/or Na₃PO₄ being added in a molar ratio with respect to the lithium present in the aqueous solution from 1:1 to 1.5:1; and
iii) separating the Li₃PO₄ from the filtrate.

Embodiments are set forth in the appended claims and in the following description and examples.

### BRIEF DESCRIPTION OF THE DRAWINGS

FIG. 1 shows the solubility of Li₃PO₄ formed upon addition of H₃PO₄ to a solution comprising Li₂SO₄ as a function of the pH and added H₃PO₄.

FIG. 2 shows the solubility of Li₃PO₄ formed upon addition of H₃PO₄ to a solution comprising Li₂SO₄ and LiOH monohydrate as a function of the pH and added H₃PO₄.

FIG. 3 shows the solubility of Li₃PO₄ formed upon addition of H₃PO₄ to a solution comprising Li₂SO₄, LiOH monohydrate and 25 wt % of a pH adjuster as described herein as a function of the pH and added H₃PO₄.

FIG. 4 shows the solubility of Li₃PO₄ formed upon addition of H₃PO₄ to a solution comprising Li₂SO₄, LiOH monohydrate and 7 wt % of a pH adjuster as described herein as a function of the pH and added H₃PO₄.

FIG. 5 shows the treatment of a residual aqueous solution comprising lithium such as LiOH and/or Li₂SO₄ with Na₃PO₄ and/or H₃PO₄ and a pH adjuster to provide a precipitate of Li₃PO₄ and a filtrate.

FIG. 6 shows a recycling process involving treatment of black mass wherein the process comprises treatment of a residual aqueous solution comprising LiOH and a residual aqueous solution comprising Li₂SO₄ with Na₃PO₄ and/or H₃PO₄ and a pH adjuster to provide a precipitate of Li₃PO₄ and a filtrate.

FIG. 7 shows a recycling process involving treatment of black mass wherein the process comprises treatment of a residual aqueous solution comprising LiOH with Na₃PO₄ and/or H₃PO₄ and a pH adjuster to provide a precipitate of Li₃PO₄ and a filtrate.

FIG. 8 shows a process for manufacturing a Cathode Active Material (CAM) wherein the process comprises treatment of a residual aqueous solution comprising lithium with Na₃PO₄ and/or H₃PO₄ and a pH adjuster to provide a precipitate of Li₃PO₄ and a filtrate.

### DESCRIPTION

An energy storage device as described herein may be a battery such as an NMC battery. As known in the art, an NMC battery is a lithium-ion battery in which the cathode comprises oxides of lithium nickel, manganese and cobalt while the anode may comprise carbon such as graphite. For instance, the graphite may be coated on copper foil.

The present disclosure provides a method for recovery of lithium from an aqueous residual solution comprising one or more lithium salts, said method comprising the steps of:
i) providing a lithium-containing aqueous residual solution;
ii) adding H₃PO₄ and/or Na₃PO₄ to the aqueous residual solution in the presence of a pH adjuster providing a pH of 6 or above thereby precipitating Li₃PO₄ and forming a filtrate, said H₃PO₄ and/or Na₃PO₄ being added in a molar ratio with respect to the lithium present in the aqueous solution from 1:1 to 1.5:1; and
iii) separating the Li₃PO₄ from the filtrate.

In some embodiments, the present disclosure provides a method for recovery of lithium from an aqueous solution comprising one or more lithium salts, said method comprising the steps of:
i.a) providing a lithium-containing aqueous solution or a solid material comprising lithium;
i.b) processing the aqueous solution or solid material, whereby an aqueous residual solution comprising a lower amount of lithium than the first aqueous solution or solid material is formed;
ii) adding H₃PO₄ and/or Na₃PO₄ to the aqueous residual solution in the presence of a pH adjuster providing a pH of 6 or above, preferably from 6 to 12, even more preferably in the range from 9 to 10, thereby precipitating Li₃PO₄ and forming a filtrate, said H₃PO₄ and/or Na₃PO₄ being added in a molar ratio with respect to the lithium present in the aqueous solution from 1:1 to 1.5:1; and
iii) separating the Li₃PO₄ from the filtrate.

In some embodiments, the method of the disclosure is a method for recovery of lithium from an energy storage device or a waste-stream from the manufacturing of a cathode active material. As detailed below, the method may comprise a number of steps to provide an aqueous residual solution.

The term “aqueous residual solution” is used herein to describe the aqueous solution that undergoes steps ii) and iii) of the method of the disclosure. The term “residual” is used as the aqueous solution may have resulted from earlier processing steps, such as processing a solid (such as black mass) to form an aqueous solution, and/or processing an aqueous solution to selectively remove certain impurities and crystallise the valuable metals.

The present disclosure is based on the finding that addition of phosphoric acid, i.e. H₃PO₄, and/or sodium phosphate Na₃PO₄ and/or adjustment of the pH allows for removal of all, or substantially all such as 95%, 96%, 97%, 98% or 99% or more, of the lithium in an aqueous solution comprising salts such as Li₂SO₄ and/or LiOH, even when the source solution or material has been processed in a previous step to remove lithium. This is a significant benefit since lithium may be recovered whereby waste of valuable lithium is minimized.

It will be appreciated that Na₂CO₃ may be used instead of H₃PO₄, and/or Na₃PO₄. Although, Na₂CO₃ allows for lithium precipitation, the solubility limits are higher (up to 1200 to 1500 ppm) which causes higher loss of lithium compared to phosphate precipitation. The recovered lithium may subsequently be recycled in various applications. For example, the recovered lithium may be used in recycling processes of energy storage devices.

Thus, the method of the present disclosure may be a method for recycling (or recovery) of lithium from an energy storage device or a waste-stream from the manufacturing of a cathode active material. In this case, the aqueous solution in step i.a) of the method of the present disclosure may originate from a battery recycling process. The battery recycling process may be free such as substantially free from sodium. In this way, recovery of sodium such as NaOH and/or Na₂SO₄ is obviated or minimized.

As used herein, the expression “substantially free from sodium” means that the component referred to is present in an amount that is equal to or less than 5 wt % such as less than 1 wt % based on the total weight of the solution or mixture. Alternatively, the battery recycling process may comprise sodium such as Na₂SO₄.

For the sodium free battery recycling process, a bipolar electrodialysis membrane may be used for processing an aqueous solution comprising Li₂SO₄ to provide a first aqueous solution comprising LiOH, a second aqueous solution comprising H₂SO₄, and a residual aqueous solution comprising Li₂SO₄. The first aqueous solution comprising LiOH is then concentrated whereby LiOH is precipitated as LiOH monohydrate and an aqueous residual solution comprising LiOH is formed. The aqueous residual solution comprising LiOH and the residual aqueous solution comprising Li₂SO₄ may then be combined to be the aqueous solution of method step i.b) which may be subjected to method steps, ii) and iii) as described herein.

The sodium containing battery recycling process comprises a step of Na₂SO₄ recovery. Following Na₂SO₄ recovery, the aqueous solution comprising LiOH is concentrated whereby LiOH is precipitated as LiOH monohydrate and an aqueous residual solution comprising LiOH is formed. The aqueous residual solution comprising LiOH may be the aqueous solution of method step i.b) which may subsequently be subjected to method steps, ii) and iii) as described herein.

The LiOH being precipitated in the method may be an amorphous solid, a crystalline solid or a combination thereof. For example, the LiOH being precipitated may be crystalline (i.e., in the form of crystals).

Alternatively, the method of the present disclosure may be applied in a manufacturing process for a Cathode Active Material. In this scenario, step i.a) of the method comprises providing a solid material comprising lithium. The solid material may be a CAM material derived in the CAM manufacturing process. In step i.b) the solid material is processed and a residual aqueous solution comprising a lower amount of lithium than the solid material is formed. In other words, the residual aqueous solution in step i.b) of the present disclosure originates from manufacturing of a Cathode Active Material (CAM).

Typically, the manufacturing of a CAM comprises preparation of a coprecipitation precursor in an aqueous solution comprising one or more transition metals such as nickel, cobalt and/or manganese. The one or more transition metals may be provided as salts such as sulfate salts. The pH of the aqueous solution may be adjusted to be alkaline, e.g., the pH may be adjusted to be from about 10 to about 12, using an alkaline aqueous solution such as an alkaline aqueous solution comprising NaOH. The coprecipitation precursor may be filtrated and dried prior to further processing.

Subsequently, a lithium containing compound such as LiOH or Li₂CO₃ is added to the coprecipitation precursor followed by calcination thereby providing the CAM. Following this the CAM may be pulverized, treated with an aqueous solution, filtrated etc. Loss of lithium may take place into the aqueous solution(s) and/or wastewater involved in the process steps. The aqueous solution comprising the lost lithium may be the aqueous solution of method step i.b) which may subsequently be subjected to method steps ii) and iii) as described herein.

When the aqueous solution in step i.a) of the method of the present disclosure originates from a battery recycling process the black mass is treated to remove impurities such as graphite, Cu, Ca, Mg, Al, Fe, Zn. The remaining valuable metals such as NMC and Li are recovered in further steps.

As used herein, black mass refers to a product obtained in the recycling of energy storing devices such as batteries. Generally, the recycling of energy storing devices such as batteries starts by sorting the batteries according to their chemical composition which is followed by crushing, shredding, filtering and washing. Plastic and metal shreds are removed, and the remaining product is referred to as black mass. The black mass typically comprises electrolyte(s), cathode and anode materials and possibly further elements.

It should be noted that as an alternative or in addition to black mass, the solution or solid material in step i.a) may be obtained from the treatment of low quality lithium containing compounds (such as Li₂CO₃), i.e., lithium containing compounds comprising one or more impurities such as calcium or potassium, with the objective of increasing their quality and make them suitable for battery grade materials. In this scenario, such a treatment step will result in obtaining a residual aqueous solution in step i.b).

When the aqueous solution in step i.a) of the method of the present disclosure originates from a battery recycling process, the aqueous solution of step i.a) or the solution(s) from which the aqueous solution of step i.a) is derived may have been treated to remove one or more of the following:
graphite,
nickel, manganese, cobalt and/or any oxides thereof,
calcium,
iron,
magnesium.

Thus, the aqueous solution of step i.a) may be free or substantially free from one or more of
graphite,
nickel, manganese, cobalt and/or any oxides thereof,
calcium,
iron,
magnesium.

When the solid material in step i.a) of the method of the present disclosure originates from a CAM manufacturing process, the material contains valuable metals such as but not limited to nickel, manganese, cobalt and lithium, depending on the chemistry of the cathode material.

As used herein, the expression “substantially free from” may intend a presence of about 10 ppm or less, such as about 5 ppm or less, such as about 1 ppm or less of the component referred. For example, the component may referred to may be present in an amount from 0.01 ppm to 50 ppm, such as from 0.01 ppm to 10 ppm, such as from 0.01 ppm to 5 ppm or such as from 0.01 ppm to 1 ppm.

The amount of lithium present in the aqueous residual solution may vary, though is typically above 8 g/L, such as above 10 g/L, typically above 15 g/L.

The upper limit of the amount of lithium which is present is defined by the solubility of the various salts, and will typically be below 35 g/L, such as below 30 g/L, or below 25 g/L.

Suitable amounts of lithium in the aqueous residual solution will therefore typically be from 8 g/L to 35 g/L, such as from 8 g/L to 30 g/L, such as from 10 g/L to 25 g/L, or from 15 g/L to 25 g/L.

The (i) H₃PO₄ and/or Na₃PO₄ and (ii) lithium salt in the method described herein may be provided in a molar ratio from 1:1 to 1.5:1, such as from 1.01:1 to 1.5:1, such as from 1.02:1 to 1.5:1, such as from 1.03:1 to 1.3:1, such as from 1.05:1 to 1.25:1, preferably from 1.05:1 to 1.2:1.

In a further example, the (i) H₃PO₄ and/or Na₃PO₄ and (ii) lithium salt may be provided in a molar ratio of 1.2:1 or 1:1.

By “molar ratio” in the context of this disclosure is meant the amount of phosphate added with respect to the lithium phosphate (i.e. Li₃PO₄) that may be produced. A molar ratio of 1:1 in the context of the present disclosure therefore means that for every one phosphate moiety present, there are three lithium moieties present in the solution, such that 1 mol of phosphate would produce 1 mol of lithium phosphate.

These molar ratios have been found to associated with a particularly high recovery of the lithium and low amount of lithium remaining in the filtrate. Without wishing to be bound by theory, the excess of phosphate with respect to lithium leads to the precipitation reaction being driven to completion, resulting in higher levels of lithium phosphate being recovered from the solution. This is particularly the case when high levels of lithium are present in the aqueous residual solution, such as above 8 g/L lithium, whereby seed precipitates of lithium phosphate that initially form drive the efficient precipitation of lithium to improve overall yields. Surprisingly, the use of a slight excess of phosphate also allows the reaction to take place at lower temperatures, and lower pH levels. The method of the disclosure therefore provides an energy efficient process that uses lower overall resources such as pH adjusting agent.

It will be appreciated that a molar ratio of for example 1.2:1 is understood to mean that the H₃PO₄ and/or Na₃PO₄ is/are used in a stoichiometric excess of 20% with respect to the lithium salt. In a further example, the molar ratio may be 1:1 meaning that the H₃PO₄/or Na₃PO₄ is/are added in an equimolar amount with respect to the lithium salt (i.e. lithium phosphate-Li₃PO₄).

The pH of step ii) of the method described herein may be from about 9 to about 11. For instance, the pH may be from about 9 to about 10, such as from about 9 to about 9.8.

For example, in step ii) of the method the (i) H₃PO₄ and/or Na₃PO₄ and (ii) lithium salt may be provided in a molar ratio about 1.2:1; and/or the pH may be from about 9 to about 10.

The pH described herein has been found to have a beneficial impact on the recovery of lithium as Li₃PO₄. Additionally, when taken in combination with the molar ratios for the (i) H₃PO₄ and/or Na₃PO₄ and (ii) lithium salt as described herein this has been found to further improve the recovery of lithium. Consequently, the filtrate will comprise very little lithium such as 1000 ppm, such as 400 ppm, such as 150 ppm, such as 100 ppm or less of lithium. For example, the filtrate may comprise 150 ppm, 100 ppm or less of lithium.

The pH adjuster of the method may comprise or consist of NaOH. The amount of the pH adjuster is added in a molar ratio with respect to the lithium present in the aqueous solution from 0.2:1 to 1.1:1. For instance, the pH adjuster may be added in a molar ratio of from about 0.2:1 to about 0.46:1 such as about 0.3:1. It has been found that the aforementioned molar ratios allow for providing a pH from about 6 to about 12, such as from about 9 to about 11, such as from about 9 to about 10, such as from about 9 to about 9.8. The pH adjuster may be added before or during a pH drop takes place in the method described herein.

It will be appreciated that step ii) of the method described herein may be performed at a temperature from about 20° C. to about 90° C., such as from about 20° C. to about 65° C., such as from about 20° C. to about 60° C., such as from about 30° C. to about 60° C., such as from about 30° C. to about 55° C., such as from about 40° C. to about 60° C., such as from about 40° C. to about 55° C., such as from about 40° C. to about 50° C., such as from about 50° C. to about 60° C., such as from about 45° C. to about 55° C. The choice of this temperature range has been found to have a beneficial impact of the solubility of the components in this method step.

The filtrate of step iii) of the method describe herein may comprise 1000 ppm such as 400 ppm, i.e. part per million, or less of lithium such as 150 ppm or 100 ppm or less or less of lithium.

The method of the present disclosure may further comprise recycling of the precipitate comprising Li₃PO₄. For example, the precipitate comprising Li₃PO₄ may be used in battery recycling for removal of impurities as described below.

The method of the present disclosure may further comprise one or more method steps comprising removal of iron and optionally further metal impurities.

### EMBODIMENTS OF THE DISCLOSURE

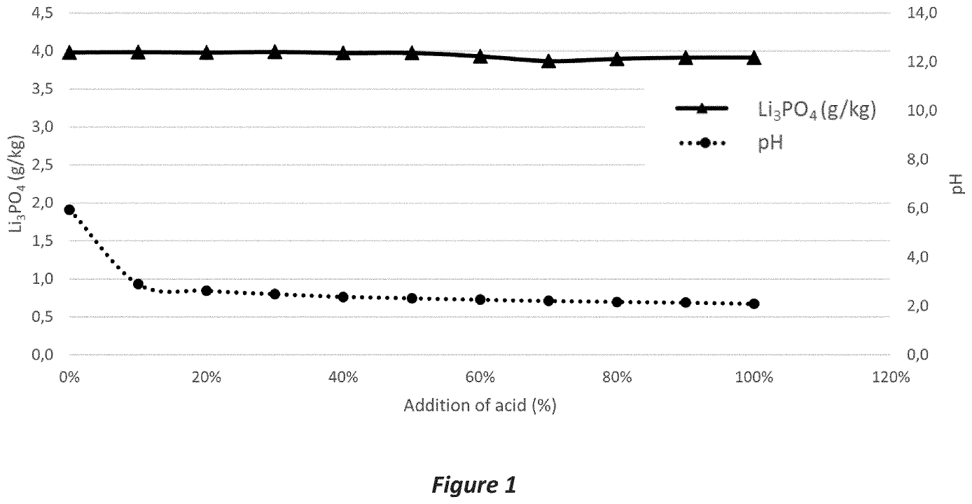

FIG. 1 shows the solubility of Li₃PO₄ formed upon addition of H₃PO₄ to a solution comprising Li₂SO₄ as a function of the pH and added H₃PO₄. Example 1 herein forms the basis for the graph.

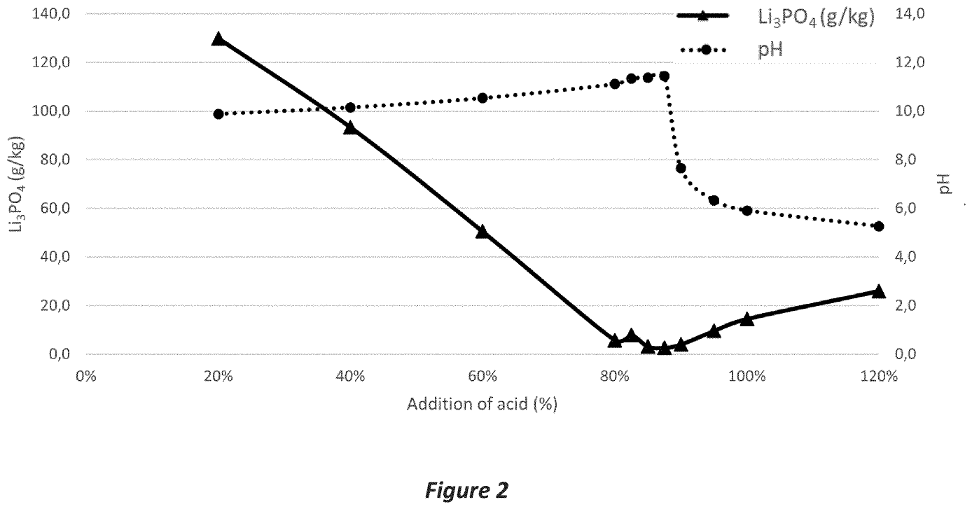

FIG. 2 shows the solubility of Li₃PO₄ formed upon addition of H₃PO₄ to a solution comprising Li₂SO₄ and LiOH monohydrate as a function of the pH and added H₃PO₄. Example 2 herein forms the basis for the graph.

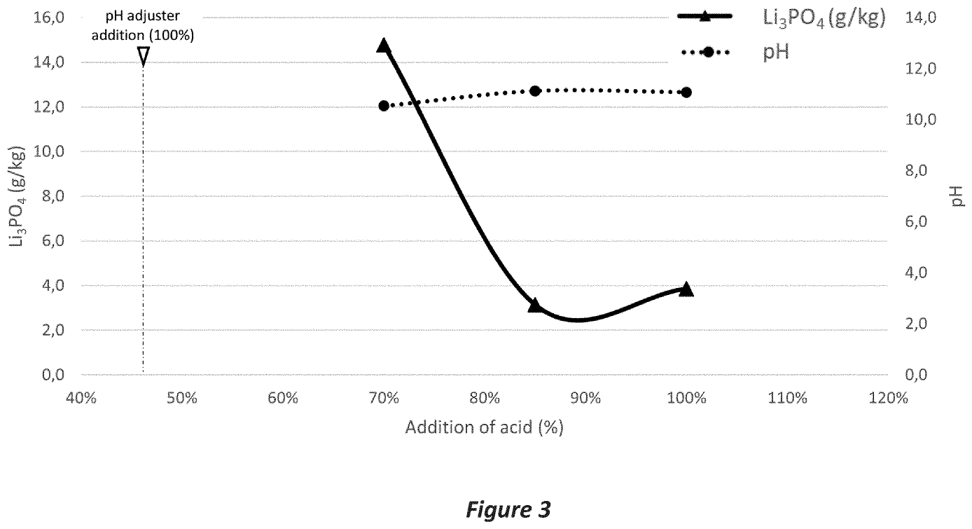

FIG. 3 shows the solubility of Li₃PO₄ formed upon addition of H₃PO₄ to a solution comprising Li₂SO₄, LiOH monohydrate and 25 wt % of a pH adjuster as described herein as a function of the pH and added H₃PO₄. Example 3 herein forms the basis for the graph.

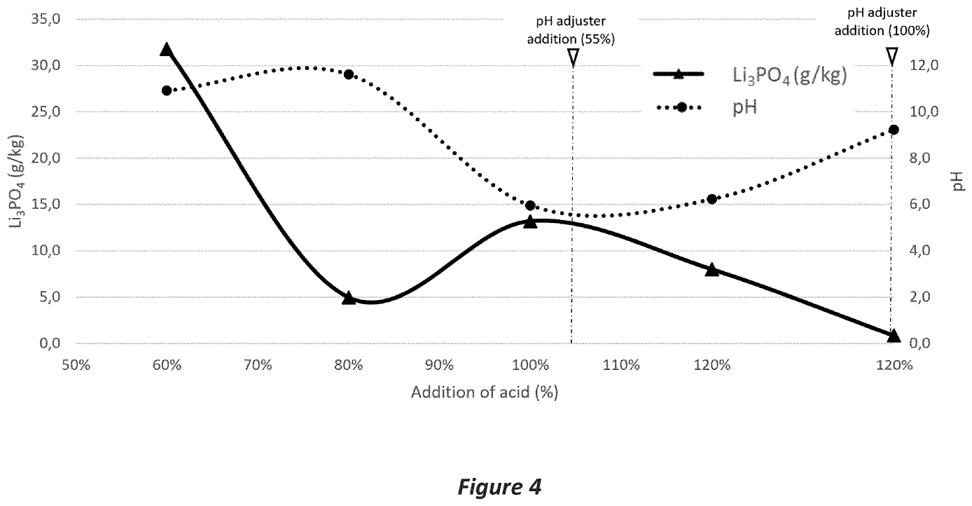

FIG. 4 shows the solubility of Li₃PO₄ formed upon addition of H₃PO₄ to a solution comprising Li₂SO₄, LiOH monohydrate and 7 wt % of a pH adjuster as described herein as a function of the pH and added H₃PO₄. Example 4 herein forms the basis for the graph.

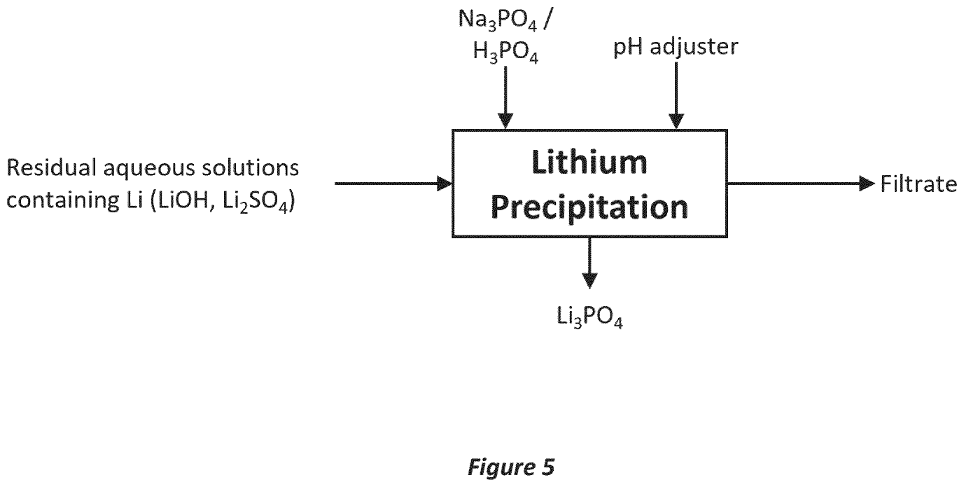

FIG. 5 shows the method of the present disclosure in which treatment of a residual aqueous solution comprising lithium such as LiOH and/or Li₂SO₄ with Na₃PO₄ and/or H₃PO₄ and a pH adjuster provides a precipitate of Li₃PO₄ and a filtrate.

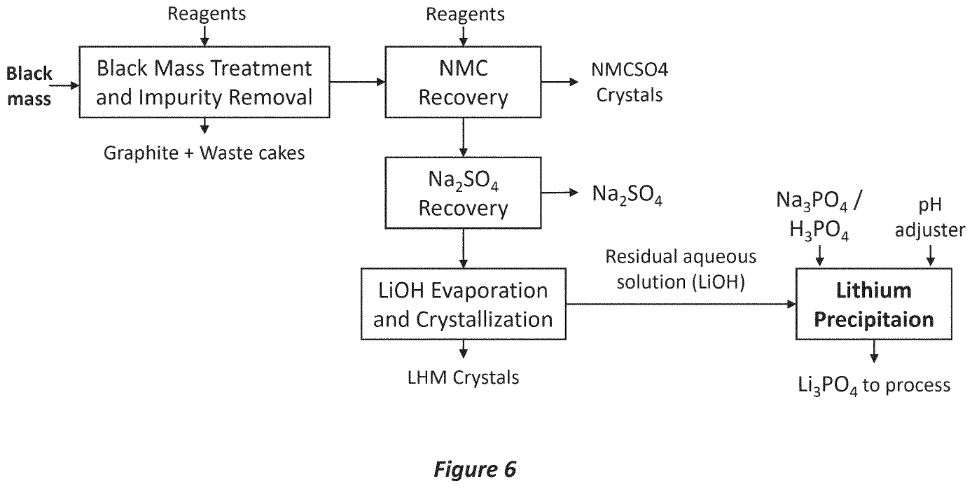

FIG. 6 shows the method of the present disclosure further comprising method steps in a sodium free battery recycling process. Black mass is treated in the battery recycling process to remove graphite and impurities which is followed by NMC recovery, i.e. recovery of sulfate crystals of nickel, manganese and cobalt and a resulting brine solution comprising Li₂SO₄ is subsequently subjected to electrodialysis wherein the brine solution is treated to provide a first aqueous solution comprising LiOH, a second aqueous solution comprising H₂SO₄, and a residual aqueous solution comprising Li₂SO₄. The first aqueous solution comprising LiOH is then concentrated whereby LiOH is precipitated and an aqueous residual solution comprising LiOH is formed. The aqueous residual solution comprising LiOH and the residual aqueous solution comprising Li₂SO₄ are then combined to be the aqueous solution of method step i.b) of the present disclosure which is subjected to method steps, ii) and iii) as described herein.

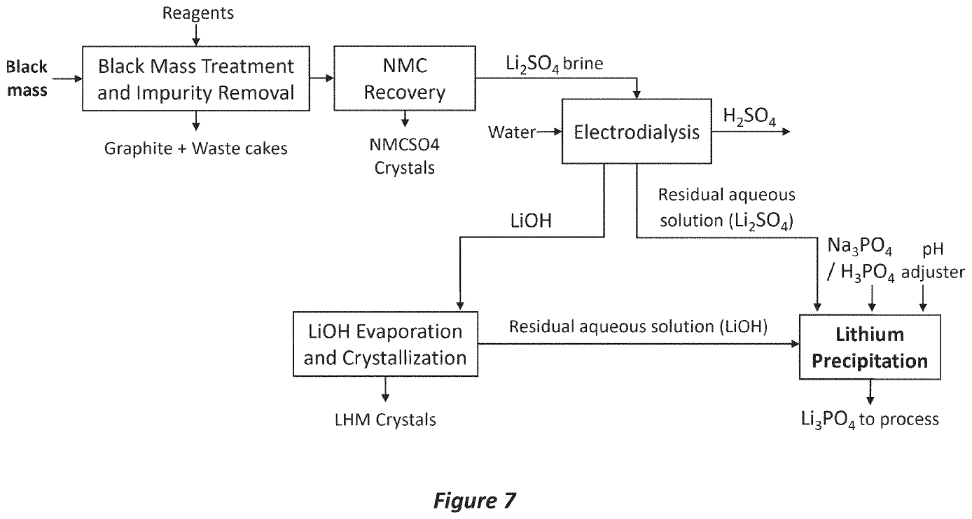

FIG. 7 shows the method of the present disclosure further comprising method steps in a sodium containing battery recycling process. Black mass is treated in the battery recycling process to remove graphite and impurities which is followed by NMC recovery, i.e. recovery of sulfate crystals of nickel, manganese and cobalt, and recovery of Na₂SO₄ resulting in an aqueous solution comprising LiOH. The aqueous solution comprising LiOH is subsequently concentrated by e.g. evaporation resulting in LiOH crystals and a residual aqueous solution comprising LiOH. The residual aqueous solution comprising LiOH then serves as the aqueous solution of method step i.b) of the present disclosure which is subjected to method steps, ii) and iii) as described herein.

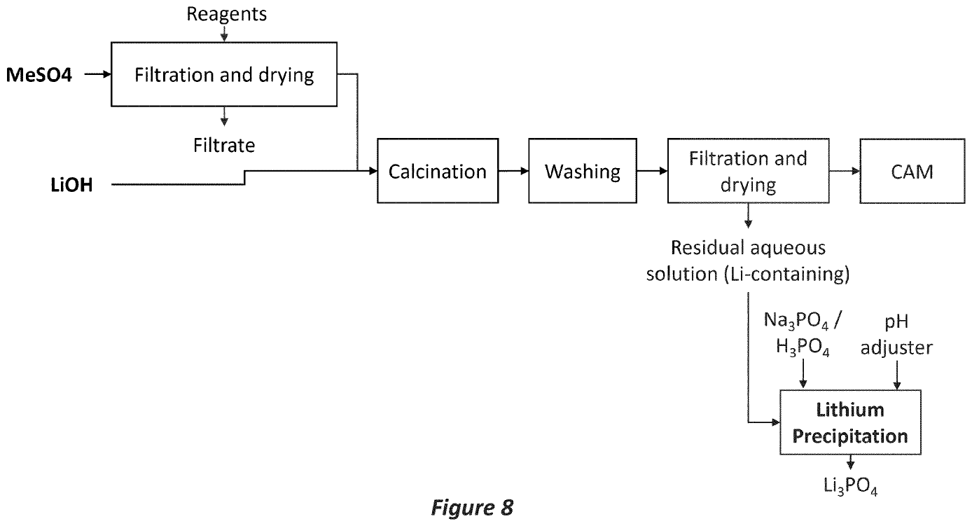

FIG. 8 shows the method of the present disclosure further comprising method steps in a process for manufacturing a Cathode Active Material (CAM). Metal sulfates (e.g. nickel sulfate, cobalt sulfate and/or manganese sulfate), which is abbreviated MeSO₄ in FIG. 8, is added to a coprecipitation precursor which is subjected to filtration and drying. LiOH is added to the filtrated and dried coprecipitation precursor which is followed by calcination, washing, filtration and drying to form a Cathode Active Material (CAM) and a residual aqueous solution comprising lithium such as lithium salt(s). The residual aqueous solution comprising lithium salt(s) then serves as the aqueous solution of method step i.b) of the present disclosure which is subjected to method steps, ii) and iii) as described herein.

The disclosure will be further described by reference to the following examples, which are not intended to limit the scope of the disclosure.

### EXAMPLES

The pH was measured using a pH meter from Mettler Toledo. The pH meter was calibrated before testing. The analytical technique used for measuring the composition of the samples (ppm of Lithium) was an Inductively Coupled Plasma-Optical Emission Spectroscopy (ICP-OES). A heating plate was used for performing all the examples maintaining the temperature at 40 degrees Celsius. For all the examples, the aqueous solution of H₃PO₄ was 15.2M and the aqueous solution comprising lithium (Li₂SO₄ and/or LiOH) variated depending on the specific example. For the examples 3 and 4 the pH adjuster used was NaOH 19.4 M.

### Abbreviations

g gram(s)
kg kilogram(s)
M molar, i.e. mole(s)/litre
NMC nickel, manganese, cobalt
ppm part(s) per million
wt % percent by weight

### Example 1

An aqueous solution of H₃PO₄ was added to an aqueous solution comprising Li₂SO₄ thereby forming Li₃PO₄. The aqueous solution comprising Li₂SO₄ had a concentration of 6.00 g/kg. FIG. 1 shows the solubility of the formed Li₃PO₄ (measured as grams per kilogram of solution) and the pH as a function of the amount of added H₃PO₄. Table 1 gathers the amount of acid added and, for each sample, the pH, the amount of Lithium in ppm and the solubility of the Li₃PO₄. The amount of acid was added up to 100%, which corresponds to a stoichiometric amount with respect to the Li₂SO₄, which corresponds to a molar ratio of 1:1.

TABLE 1

| Amount of | | | |
|---|---|---|---|
| added H₃PO₄ | | Li | Solubility of |
| (%) | pH | (ppm)) | Li₃PO₄ (g/kg) |
| 0% | 6.0 | 716 | 4.0 |
| 10% | 2.9 | 717 | 4.0 |
| 20% | 2.6 | 715 | 4.0 |
| 30% | 2.5 | 717 | 4.0 |
| 40% | 2.4 | 715 | 4.0 |
| 50% | 2.3 | 715 | 4.0 |
| 60% | 2.3 | 707 | 3.9 |
| 70% | 2.2 | 695 | 3.9 |
| 80% | 2.2 | 701 | 3.9 |
| 90% | 2.1 | 704 | 3.9 |
| 100% | 2.1 | 704 | 3.9 |
| Filtrate | | 691 | |

It was observed that the pH dropped after the addition of 10% of the aqueous solution of H₃PO₄. Further, no precipitation of Li₃PO₄ was observed. It was concluded that a low pH such as a pH below 6 does not provide a precipitate of Li₃PO₄. The amount of acid was added up to 100%, which corresponds to a stoichiometric amount with respect to the Li₂SO₄, which corresponds to a molar ratio of 1:1.

The aqueous solution comprising lithium in the following examples (i.e., Examples 2, 3 and 4) had a concentration of 4.00 g/kg of Li₂SO₄ and 133.35 g/kg of the LiOH monohydrate.

### Example 2

An aqueous solution of H₃PO₄ was added to an aqueous solution comprising Li₂SO₄ and LiOH monohydrate thereby forming Li₃PO₄. FIG. 2 shows the solubility of the formed Li₃PO₄ (measured as grams per kilogram of solution) and the pH as a function of the amount of added H₃PO₄. Table 2 gathers the amount of acid added and, for each sample, the pH, the amount of Lithium in ppm and the solubility of the Li₃PO₄. The amount of acid was added up to 120%, which is a 20% excess in relation to a stoichiometric amount with respect to the Li₂SO₄, which corresponds to a molar ratio of 1.2:1.

TABLE 2

| Amount of | | | |
|---|---|---|---|
| added H₃PO₄ | | Li | Solubility of |
| (%) | pH | (ppm) | Li₃PO₄ (g/kg) |
| 20% | 9.9 | 23353 | 129.9 |
| 40% | 10.1 | 16772 | 93.3 |
| 60% | 10.5 | 9069 | 50.5 |
| 80% | 11.1 | 1037 | 5.8 |
| 85% | 11.4 | 564 | 3.1 |
| 90% | 7.7 | 719 | 4.0 |
| 95% | 6.3 | 1718 | 9.6 |
| 100% | 5.9 | 2607 | 14.5 |
| 120% | 5.3 | 4672 | 26.0 |
| Filtrate | | 4746 | |

It was observed that the pH remained high at the beginning of the addition of the H₃PO₄ and then dropped after about 85% of added H₃PO₄. The large drop in pH is believed to be due to the release of protons upon reaction between Li₂SO₄ and H₃PO₄. The precipitation of Li₃PO₄ was found to take place mainly between pH 6 and pH 11. However, while precipitation was the most efficient in this range, it was observed that precipitation started already around pH 5, and continued also above pH 11.

### Example 3

An aqueous solution of H₃PO₄ was added to an aqueous solution comprising Li₂SO₄ and LiOH monohydrate thereby forming Li₃PO₄. Furthermore, NaOH was added as a pH adjuster to the aqueous solution comprising Li₂SO₄ and LiOH monohydrate in order to adjust the pH. The amount of the added NaOH was 25 wt % based on the total weight of the aqueous solution before addition of the H₃PO₄. FIG. 3 shows the solubility of the Li₃PO₄ and the pH as a function of the amount of acid added and it is also represented when the pH adjuster was added. Table 3 gathers the amount of acid added, the addition of the pH adjuster, and, for each sample, the pH, the amount of Lithium in ppm and the solubility of the Li₃PO₄. The amount of acid was added up to 100%, which corresponds to a stoichiometric amount with respect to the Li₂SO₄, which corresponds to a molar ratio of 1:1. The pH adjuster was added after the addition of 40% of the phosphoric acid.

TABLE 3

| Amount of | % Of total | | | Solubility |
|---|---|---|---|---|
| added H₃PO₄ | pH adjuster | | Li | of Li₃PO₄ |
| (%) | added | pH | (ppm) | (g/kg) |
| 40% | | 9.6 | — | — |
| | 100% | 10.8 | — | — |
| 60% | | 10.3 | — | — |
| 70% | | 10.5 | 2655 | 14.8 |
| 85% | | 11.1 | 566 | 3.1 |
| 100% | | 11.1 | 695 | 3.9 |
| Filtrate | | | 408 | |

It was observed that the addition of the pH adjuster allowed for maintaining a high pH also when the amount of added H₃PO₄ exceeded 85% which reduced the solubility of the formed Li₃PO₄. Further, the isolated solid composition was found to comprise Li₃PO₄, Na₂SO₄ and water in the amounts shown in Table 4.

TABLE 4
Solid composition (wt %)

| | |
|---|---|
| Li₃PO₄ | 50 |
| Na₂SO₄ | 3 |
| Water | 47 |

### Example 4

This example was performed in the same way as Example 3. However, the amount of added NaOH was 7 wt % based on the total weight of the aqueous solution before addition of the H₃PO₄. FIG. 4 shows the solubility of the Li₃PO₄ and the pH as a function of the amount of acid added and it is also represented when the pH adjuster was added. Table 5 gathers the amount of acid added, the addition of the pH adjuster, and, for each sample, the pH, the amount of Lithium in ppm, the removal of lithium as well as the solubility of the Li₃PO₄. The amount of acid was added up to 120%, which is a 20% excess in relation to a stoichiometric amount with respect to the Li₂SO₄, which corresponds to a molar ratio of 1.2:1. The pH adjuster was added in three steps; 55% of the total was added after the addition of 100% stoichiometric amount of phosphoric acid and the rest was added in two separate steps after the addition of the remaining phosphoric acid.

TABLE 5

| | % Of total | | | | |
|---|---|---|---|---|---|
| Amount of | pH | | | | |
| added H₃PO₄ | adjuster | | Li | Removal | Li₃PO₄ |
| (%) | added | pH | (ppm) | (%) | (g/kg) |
| 60% | | 10.9 | 5709 | 73.4 | 31.8 |
| 80% | | 11.6 | 894 | 95.0 | 5.0 |
| 100% | | 6.0 | 2374 | 88.4 | 13.2 |
| | 55% | 11.4 | — | | — |
| 120% | | 6.2 | 1437 | 92.8 | 8.0 |
| | 72% | 6.7 | — | | — |
| | 100% | 9.2 | 152 | 99.2 | 0.8 |
| Filtrate | | | 141 | 99.3 | |

It was observed that a pH from 6 to 12 allowed for removing most of the formed Li₃PO₄. In particular, it was observed that a pH from 9-11 such as 9-10 was beneficial for removing the Li₃PO₄. However, as noted above in connection with Example 2, precipitation also occurs below pH 6 albeit to a lesser extent. Further, it should be appreciated that while most of the lithium will have precipitated at pH 12, this does not constitute a fixed upper limit since precipitation will still occur if the pH is brought to even higher levels. Hence, it can be concluded that a pH of 5 or above will cause lithium to precipitate, and a pH of 6 or above will allow for removing significant amounts of lithium. It was also observed that using an excess of the H₃PO₄, such as a 20% excess with respect to the stoichiometric amount, was beneficial for removing the Li₃PO₄. Moreover, it was found that only a low amount of the pH adjuster such as from 5-10 wt %, such as 7 wt %, was sufficient to achieve the desired pH of 9-11.

The isolated solid composition was found to comprise Li₃PO₄, Na₂SO₄ and water in the amounts shown in Table 6. A comparison of Table 6 with Table 4 in Example 3 shows that the amount of formed Li₃PO₄ in this example was higher than that in Example 3, and that the amount of Na₂SO₄ in this example was lower than that in Example 3. Thus, the increased formation of Li₃PO₄ in this example is accompanied by a lower amount of the by-product Na₂SO₄.

TABLE 6
Solid composition (wt %)

| | |
|---|---|
| Li₃PO₄ | 56.94 |
| Na₂SO₄ | 0.06 |
| Water | 43.00 |

1. A method for recovery of lithium from an aqueous residual solution comprising one or more lithium salts, said method comprising the steps of:
i) providing a lithium-containing aqueous residual solution;
ii) adding H₃PO₄ and/or Na₃PO₄ to the aqueous residual solution in the presence of a pH adjuster providing a pH of from 9 to 10 at a temperature of from about 20° C. to about 65° C. thereby precipitating Li₃PO₄ and forming a filtrate, said H₃PO₄ and/or Na₃PO₄ being added in a molar ratio with respect to the lithium present in the aqueous solution from 1:1 to 1.5:1; and
iii) separating the Li₃PO₄ from the filtrate.

2. The method of claim 1, wherein step ii) further comprises providing a pH from 9 to 9.8.

3. The method of claim 1 or, wherein, in step ii), said H₃PO₄ and/or Na₃PO₄ are added in a molar ratio with respect to the lithium present in the aqueous solution from 1.05:1 to 1.25:1.

4. The method of claim 1, wherein step ii) is performed at a 20 temperature of from about 30° C. to about 60° C.

5. The method of claim 1, wherein the aqueous residual solution contains from 15 g/L to 25 g/L lithium.

6. The method according to claim 1, wherein the method is a method for recovery of lithium from an energy storage device or a waste-stream from the manufacturing of a cathode active material.

7. The method of claim 1, wherein the aqueous residual solution comprises LiOH and/or Li₂SO₄—.

8. The method according to claim 6, wherein step i) comprises:
i.a.) providing a lithium-containing aqueous solution or a solid material comprising lithium; and
i.b) processing the aqueous solution or solid material, whereby an aqueous residual solution comprising a lower amount of lithium than the first aqueous solution or solid material is formed.

9. The method of claim 8, wherein the aqueous residual solution results from the processing of black mass in a sodium free battery recycling process, wherein in Step i.b):
an aqueous solution comprising Li₂SO₄ is processed using a bipolar electrodialysis membrane to provide a first aqueous solution comprising LiOH, a second aqueous solution comprising H₂SO₄, and a residual aqueous solution comprising Li₂SO₄;
the first aqueous solution comprising LiOH is then concentrated whereby LiOH is precipitated as LiOH monohydrate and an aqueous residual solution comprising LiOH is formed;
the aqueous residual solution comprising LiOH and the residual aqueous solution comprising Li₂SO₄ may then be combined to provide the aqueous residual solution.

10. The method of claim 8, wherein the aqueous residual solution results from the processing of black mass in a sodium containing battery recycling process, wherein in step i.b):
an aqueous solution containing LiOH and Na₂SO₄ is processed to recover Na₂SO₄; and
the aqueous solution comprising LiOH is concentrated whereby LiOH is precipitated as LiOH monohydrate and an aqueous residual solution comprising LiOH is formed.

11. The method of claim 8, wherein:
the method is for recovery of lithium from a cathode active material manufacturing process,
step i.a) comprises providing a solid material comprising lithium, and
step i.b) comprises processing the solid material to provide an aqueous residual solution comprising a lower amount of lithium than the solid material.

12. The method according to claim 8, wherein the aqueous solution of step i.a) has been treated to remove one or more of the following: graphite, nickel, manganese, cobalt and/or any oxides thereof, calcium, iron, magnesium.

13. The method according to claim 1, wherein the pH adjuster comprises NaOH.

14. The method according to claim 13, wherein the amount of the pH adjuster is added in a molar ratio with respect to the lithium present in the aqueous solution from 0.2:1 to 1.1:1 or from 0.2:1 to 0.46:1.

15. The method according to claim 1, wherein the filtrate comprises 400 ppm or less of lithium such as 150 ppm or less of lithium.

16. The method according to claim 1, further comprising recycling of the precipitate comprising LisPC in one or more process steps of the method.

17. The method according to claim 16, wherein the method further comprises one or more steps comprising removal of iron and optionally further metal impurities.
